(19) United States
(12) Patent Application Publication
(10) Pub. No.: US 2012/0306713 A1
(43) Pub. Date: Dec. 6, 2012

(54) DUAL-POLARISATION DIELECTRIC RESONATOR ANTENNA

(75) Inventors: Rohith Kunnath Raj, Toulouse (FR); Stéphane Thuries, Toulouse (FR)

(73) Assignee: AXESS EUROPE, Toulouse (FR)

(21) Appl. No.: 13/505,204

(22) PCT Filed: Oct. 28, 2010
(86) PCT No.: PCT/EP2010/066399

§ 371 Date: Aug. 13, 2012

(30) Foreign Application Priority Data
Nov. 2, 2009 (FR) 09 57737

(51) Int. Cl. H01Q 15/08

(52) U.S. Cl. 343/785

(57) ABSTRACT

The invention concerns a dual-polarisation antenna comprising:
a microstrip substrate (1) covered, on a first face, with a metallisation (M) and, on a face opposite to the first face, with two microstrip lines;
a dielectric resonator (2) having the form of a cylinder of revolution fixed to an etching (4) formed in the substrate, a first end of a first one of the two microstrip lines forming a first port of the antenna and a first end of the second microstrip line forming a second port of the antenna; and
an electrically conductive linear element (3) placed in contact with the dielectric resonator and connected to a second end of the first line (L1), via a hole (5) formed in the substrate (1), a second end of the second line (L2) being substantially vertical to the etching.

### TECHNICAL FIELD AND PRIOR ART

The invention concerns a dual-polarisation dielectric resonator antenna. The invention also concerns a network antenna consisting of elementary antennas arranged in the form of N rows and M columns, each elementary antenna of the network antenna being a dual-polarisation dielectric resonator antenna according to the invention.

One field of application of the antenna of the invention is to send/receive signals from a satellite to mobile platforms such as for example aircraft, trains, boats, etc.

The antenna of the invention is intended to be used in phase-control network antennas. Phase-control network antennas use the principle of semi-electronic scanning in which a small proportion of the angular variation of the wave transmitted is done by electronic scanning, the rest of the variation being made by mechanical means. A limitation to the scanning is due to the geometry of the pattern of the radiating element.

Phase-control network antennas have been developed that use microstrip planar antennas with printed dipoles. The gain of a microstrip planar antenna with printed dipoles decreases when the scanning angle diverts from the direction perpendicular to the axis of the dipoles. The result is a reduction in the equivalent radiated isotropic power for high scanning angles. Mechanical devices are then designed to incline the structure of the antenna. In addition, microstrip antennas have by nature a small bandwidth because of the very high Q factor of the resonators. This is also another drawback.

A dual-polarisation dielectric resonator antenna is also known from the document “Hook- and 3-D J-shaped probe excited dielectric resonator antenna for dual polarisation applications” (R. Chair, A. A. Kishk and K. F. Lee, IEE Proc.-Microw. Antennas Propag., vol. 153, N° 3, June 2006). In order to broaden the bandwidth of the antenna, a cylindrical dielectric resonator is provided, hollowed out in its bottom part, and an excitation system that comprises four wire elements based in the recess of the dielectric resonator. Such a dielectric resonator antenna has a particularly complex structure.

The dual-polarisation dielectric resonator antenna of the invention does not have the drawbacks of the antennas mentioned above.

### DISCLOSURE OF THE INVENTION

The invention concerns a dual-polarisation antenna comprising:
a microstrip substrate having a first face covered with a metallisation and a second face, opposite to the first face, covered by two microstrip lines having axes substantially perpendicular to each other, an etching being formed in the metallisation, the etching having a cross-section in the form of a rectangle having a large side and a small side, the projection, on the second face, of the axis of symmetry of the rectangle that is parallel to the large side being substantially aligned with the axis of a first line from the two lines;
a dielectric resonator having the form of a cylinder of revolution fixed, substantially centred, on the etching formed in the metallisation, the axis of the first line and the axis of the second line having a point of intersection on the axis of the cylinder of revolution, a first end of the first line forming a first port of the antenna and a first end of the second line forming a second port of the antenna; and
an electrically conductive linear element having an axis substantially parallel to the axis of revolution of the cylinder, the electrically conductive linear element being placed in contact with the dielectric resonator and being electrically connected to a second end of the first line, via a hole formed in the substrate, on the same side as the first face, a second end of the second line being substantially beyond the etching, the length of the second line between the first and second ends thereof being substantially equal to one quarter of the wavelength of a wave the frequency of which is the centre frequency of a utilisation band of the antenna.

In a particularly advantageous embodiment of the invention, two additional parallel linear etchings are formed at the ends of the etching in the form of rectangle, so as to constitute, with the etching in the form of a rectangle, an etching in the form of an “H”.

### BRIEF DESCRIPTION OF THE FIGURES

Other features and advantages of the invention will emerge from a reading of a preferential embodiment made with reference to the accompanying figures, among which:

FIG. 1 shows a perspective view of a dielectric resonator antenna according to a first embodiment of the invention;

FIG. 2 shows a view from below of the dielectric resonator antenna according to the first embodiment of the invention;

FIGS. 3A, 3B, 3C show respectively a plan view (FIG. 3A) and two side views (FIGS. 3B and 3C) of the dielectric resonator antenna according to the first embodiment of the invention;

FIGS. 4A and 4B illustrate the reflection and transmission parameters, commonly referred to as S-parameters, of an antenna according to the invention that works respectively in transmission and reflection;

FIGS. 5A and 5B show respectively the distribution of the signal transmitted in the E-plane and in the H-plane of an antenna according to the invention when a first port of the antenna is excited;

FIGS. 6A and 6B show respectively the distribution of the signal transmitted in the E-plane and in the H-plane, when a second port of the antenna is excited;

FIG. 7 shows a perspective view of a dielectric resonator antenna according to a second embodiment of the invention;

FIG. 8 shows a plan view of a dielectric resonator antenna according to the second embodiment of the invention;

FIG. 9 shows the S-parameters in reflection of an antenna according to the second embodiment of the invention;

FIG. 10 shows an example of a network antenna according to the invention.

In all the figures, the same references designate the same elements.

### DETAILED DISCLOSURE OF PARTICULAR EMBODIMENTS OF THE INVENTION

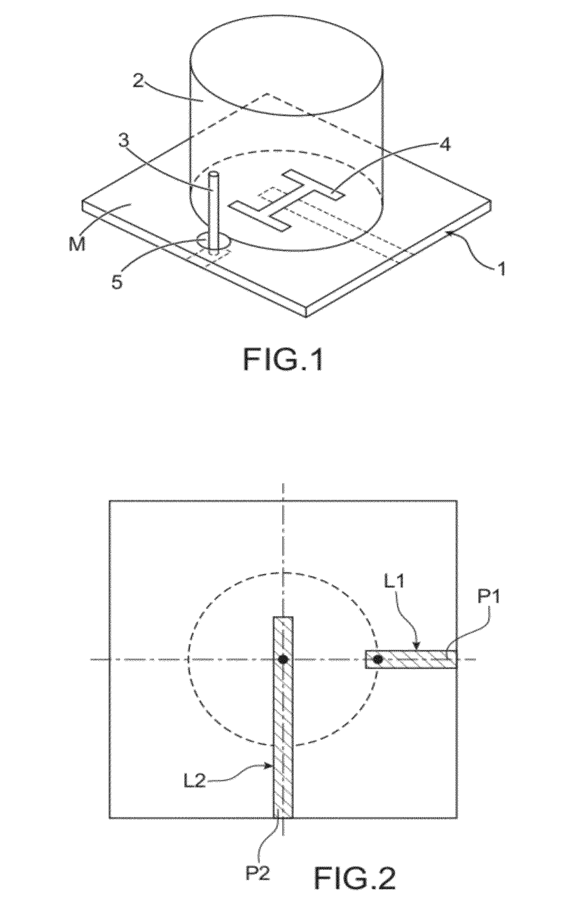

FIG. 1 shows a perspective view of a dielectric resonator antenna according to a first variant of a first embodiment of the invention and FIG. 2 shows a view from below of the antenna shown in FIG. 1.

The antenna comprises a dielectric substrate 1, a dielectric resonator 2 having the shape of a cylinder of revolution, and an electrically conductive rod 3 with a very small diameter. The dielectric resonator 2 is fixed to the substrate 1, for example by adhesive bonding. The face of the substrate 1 to which the dielectric resonator is fixed is entirely covered by a metallisation layer M, with the exception of an H-shaped etched area. The dielectric resonator 2 fixed to the substrate 1 covers the etched area devoid of metallisation in a substantially centred fashion, that is to say so that the centre of the etched area is placed substantially opposite the centre of the face of the dielectric resonator that is fixed to the substrate. The face of the substrate that is opposite to the face to which the dielectric resonator is fixed is not covered with any particular material, with the exception of two conductive lines L1, L2, the axes of which are perpendicular and intersect at a point situated on the axis of the cylinder formed by the dielectric resonator. The projection of the horizontal bar of the H, on the face of the substrate where the lines L1 and L2 are etched, is substantially aligned with the axis of the line L1. A first end of the line L1 constitutes a first port P1 of the antenna and a first end of the line L2 constitutes a second port P2 of the antenna. The line L2 has a second end in open circuit and the length thereof is substantially equal to one quarter of the wavelength of a wave the frequency of which is the centre frequency of the utilisation band of the antenna. An opening 5 is formed, in the substrate 1, on the same side as the face covered by the metallisation M, and the electrically conductive rod 3 is placed in the opening 5 so that a first one of its ends is put in electrical contact, for example by welding, with a second end of the line L1. Preferentially, the opening 5 is formed in the substrate 1 so that, once the rod 3 and the resonator 2 are fixed, the rod 3 and the resonator 2 are in contact with each other. The electrically conductive rod 3 is for example produced from copper, gold, etc. The dielectric substrate 1 is for example ROGER 4003 C material with a relative dielectric constant equal to 3.38. Other materials can also be used, such as for example alumina, aluminium nitride, low temperature co-fired ceramic, etc. The thickness of the substrate 1 is for example 0.813 mm. The dielectric resonator 2 is produced for example from aluminium nitride AlN.

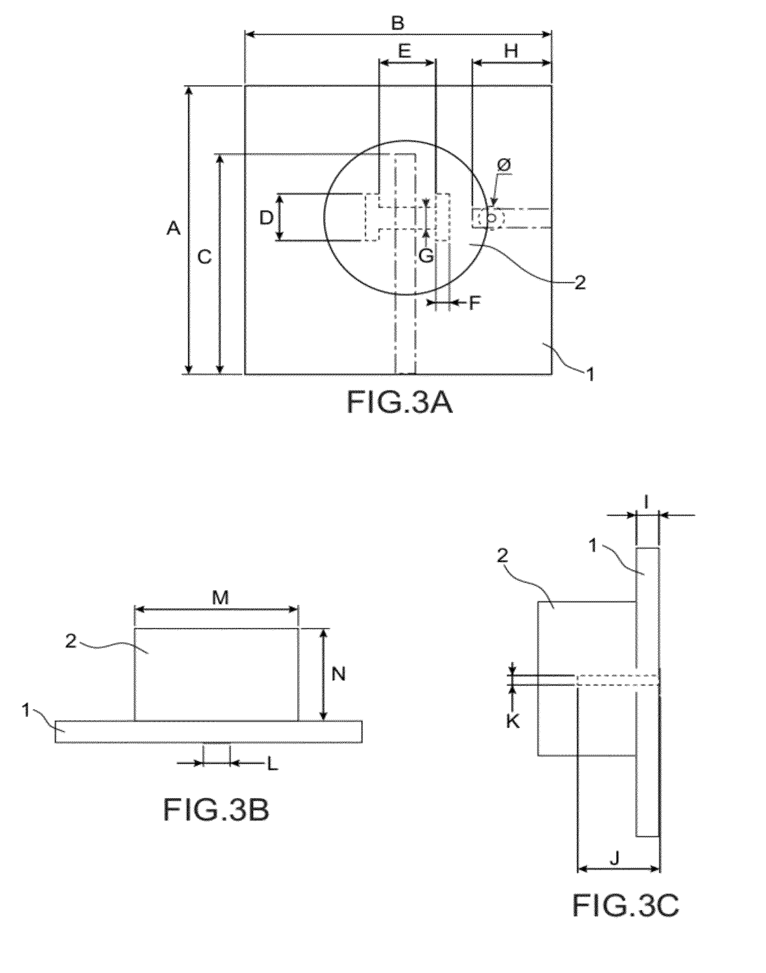

FIGS. 3A, 3B, 3C show respectively a plan view (FIG. 3A) and two side views (FIGS. 3B and 3C) of the dielectric resonator antenna according to a first embodiment of the invention. FIGS. 3A, 3B, 3C illustrate the geometry of the antenna with reference to the dimensions of the various elements that make it up. Numerical values of these dimensions are specified, by way of example, in the two tables below for firstly a functioning in reception (frequency band 10.7 GHz-12.75 GHz; see table 1) and secondly functioning in transmission (frequency band 14 GHz-14.5 GHz; see table 2).

For the values given in tables 1 and 2 below, the substrate is made from the dielectric material with a relative dielectric constant of 3.38 mentioned above and the dielectric resonator is made from aluminium nitride (AlN) with a relative dielectric constant of 8. All the dimensions are given in millimetres.

Thus:
A and B are the dimensions of the sides of the substrate 1;
C is the length of the line L2;
D is the length of the two vertical bars of the H;
E is the distance between the two vertical bars of the H;
F is the width of each of the vertical bars of the H;
G is the width of the horizontal bar of the H;
H is the length of the second line L1;
I is the thickness of the substrate 1;
J is the height of the conductive rod 3 taken from the face of the substrate 1 where the lines L1 and L2 are etched;
K is the diameter of the rod 3;
L is the width of the lines L1 and L2;
M is the diameter of the dielectric resonator 2;
N is the height of the dielectric resonator 2;
Φ is the diameter of the opening in which the rod 3 is placed.

TABLE 1

| | |
|---|---|
| A | 50 |
| B | 50 |
| C | 28 |
| D | 2.4 |
| E | 2 |
| F | 0.5 |
| G | 0.9 |
| H | 22.1 |
| I | 0.813 |
| J | 5 |
| K | 0.2 |
| L | 1 |
| M | 6 |
| N | 8.7 |
| Φ | 1 |

TABLE 2

| | |
|---|---|
| A | 50 |
| B | 50 |
| C | 29 |
| D | 2.4 |
| E | 2 |
| F | 0.5 |
| G | 0.9 |
| H | 22.5 |
| I | 0.813 |
| J | 5 |
| K | 0.2 |
| L | 1 |
| M | 5.2 |
| N | 7.7 |
| Φ | 1 |

The lines L1 and L2 are respectively connected to the ports P1 and P2 of the antenna. A first end of the line L1 thus constitutes the port P1 of the antenna and a first end of the line L2 constitutes the port P2. The lines L1 and L2 are perpendicular to each other in order to obtain the two vertical and horizontal linear polarisations. In transmission, at least one of the two ports P1, P2 is excited by a transmission signal according to the polarisation or polarisations that it is wished to transmit. In reception, the signals received on the ports P1 and P2 are transmitted to the processing circuits.

According to a first variant of the first embodiment of the invention, the line L1 connects the port P1 to an excitation element 3 that is in the form of an electrically conductive rod. According to the second variant of the first embodiment of the invention, the port P1 is connected to an excitation element that is a vertical conductive line printed on the dielectric resonator 2. A connection between the line L1 and the conductive line printed on the dielectric resonator is then effected by a conductive wire, a first side of which is welded to the line L1 and a second side of which is welded to the printed line on the dielectric resonator.

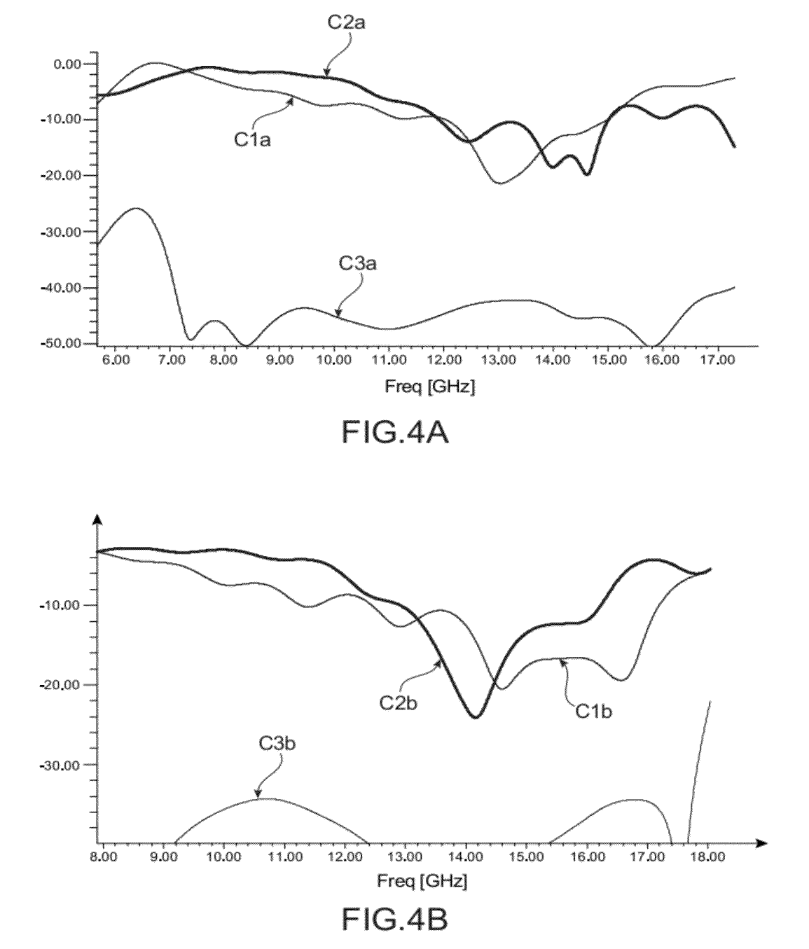

FIGS. 4A and 4B show respectively the S-parameters of an antenna designed for reception and the S-parameters of an antenna designed for transmission according to the first variant of the first embodiment of the invention. The curves C1a, C2a and C3a in FIG. 4A show respectively, as a function of the frequency and expressed in decibels, the coefficient of reflection S11a of the port P1, the coefficient of reflection S22a of the port P2 and the coefficient of transmission S21a of the port P1 to the port P2 of the reception antenna. The curves C1b, C2b and C3b in FIG. 4B show respectively, as a function of the frequency and expressed in decibels, the coefficient of reflection S11b of the port P1, the coefficient of reflection S22b of the port P2 and the coefficient of transmission S21b of the port P1 to the port P2 of the transmission antenna.

The reception band lies between 10.7 GHz and 12.75 GHz and the transmission band between 14 GHz and 14.5 GHz. For the reception antenna, it appears that the coefficient S11a is below −10 dB, the coefficient S22a below −16 dB and the coefficient S21a below −42 dB. For the transmission antenna, it appears that the coefficient of reflection S11b is between −14 dB and −20 dB, the coefficient of reflection S22b between −22 dB and −18 dB and the coefficient of transmission S21b below −40 dB. Persons skilled in the art can note the quality of the results obtained.

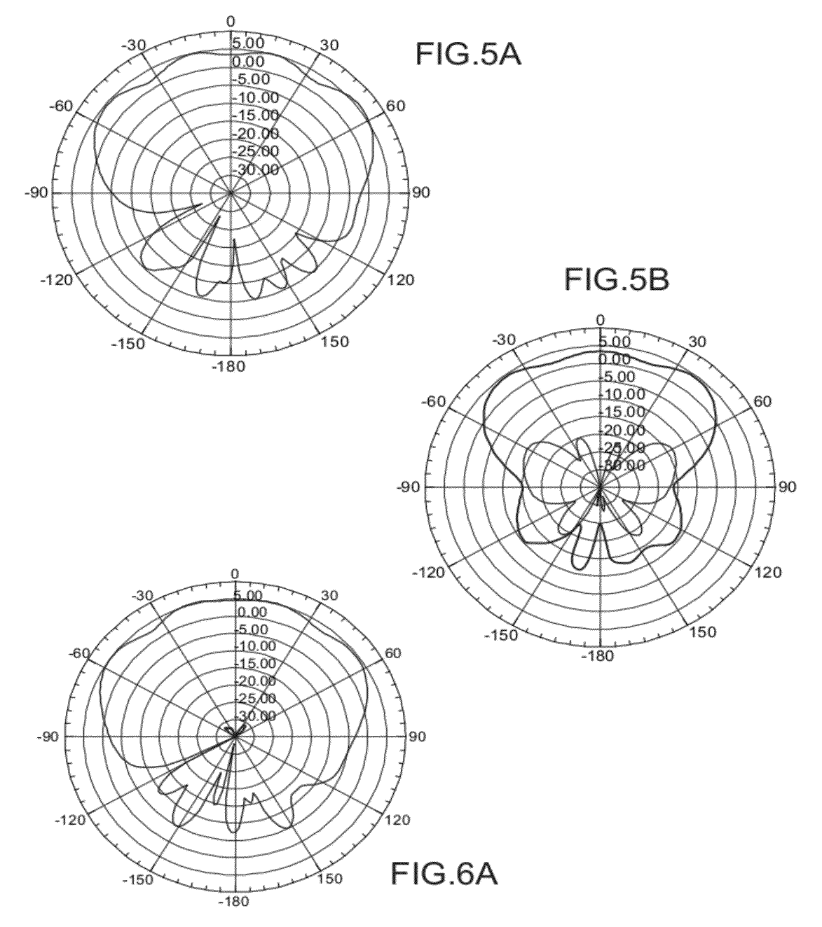

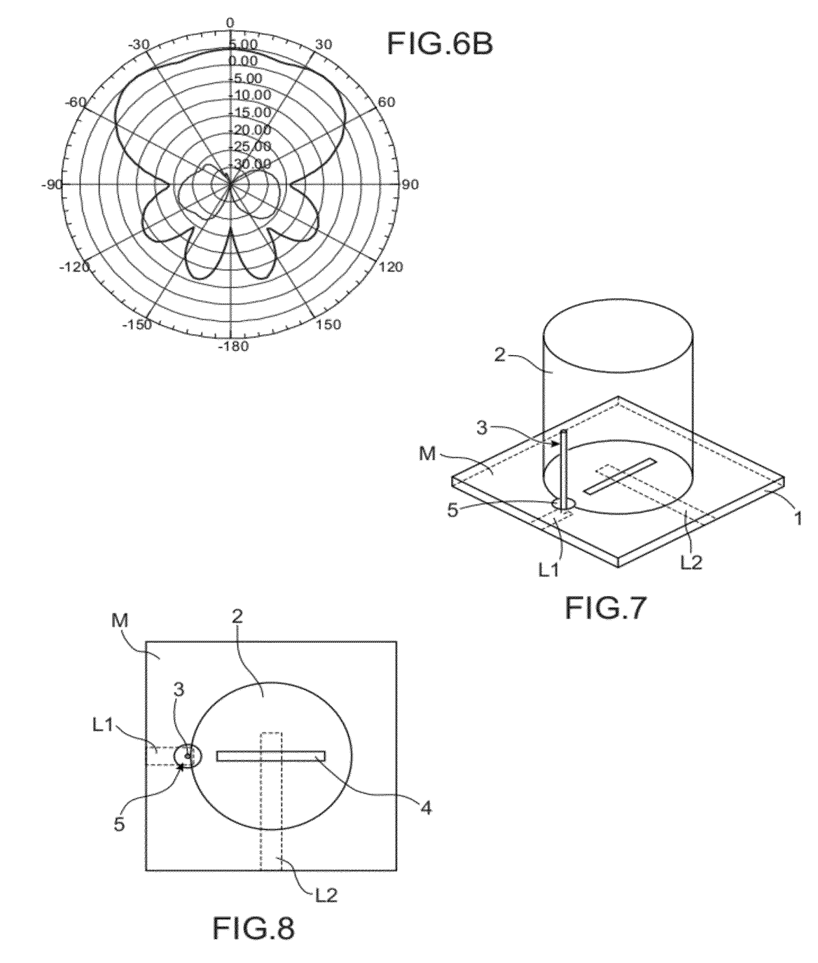

FIGS. 5A and 5B show respectively, expressed in decibels, the distribution of the signal transmitted in the E-plane and in the H-plane of a transmission antenna according to the invention when the port P1 of the antenna is excited, and FIGS. 6A and 6B show respectively, expressed in decibels, the distribution of the signal transmitted in the E-plane and in the H-plane of a transmission antenna according to the invention when the port P2 of the antenna is excited. As is known to persons skilled in the art, the E-plane and the H-plane are respectively the plane containing the electrical field vector and the maximum radiation direction and the plane containing the magnetic field vector and the maximum radiation direction. It is clear that the antenna transmits a wave having a radiation with a wide angular aperture on the two ports P1, P2. The angular aperture can be further improved at the scanning antenna by sequential rotation. The difference in gain that exists between the two ports is taken into account for generating the biasing state of the wave that is transmitted.

FIGS. 7 and 8 show respectively a perspective view and a plan view of a dielectric resonator antenna according to a second embodiment of the invention. According to the second embodiment of the invention, the substrate 1 is a low temperature co-fired ceramic (LTCC), for example Ferro A6M, and the opening 4 etched in the earth plane has a cross section in the form of a rectangle having a large side and small side. The projection, on the face where the lines L1 and L2 are etched, of the axis of symmetry of the rectangle that is parallel to the large side of the rectangle is substantially aligned with the axis of the line L1. All the other elements of the antenna are identical to those of the first embodiment of the invention. The large side of the rectangle is for example substantially equal to two thirds of the diameter of the dielectric resonator and the small side of the rectangle for example to half the width of the lines L1 and L2.

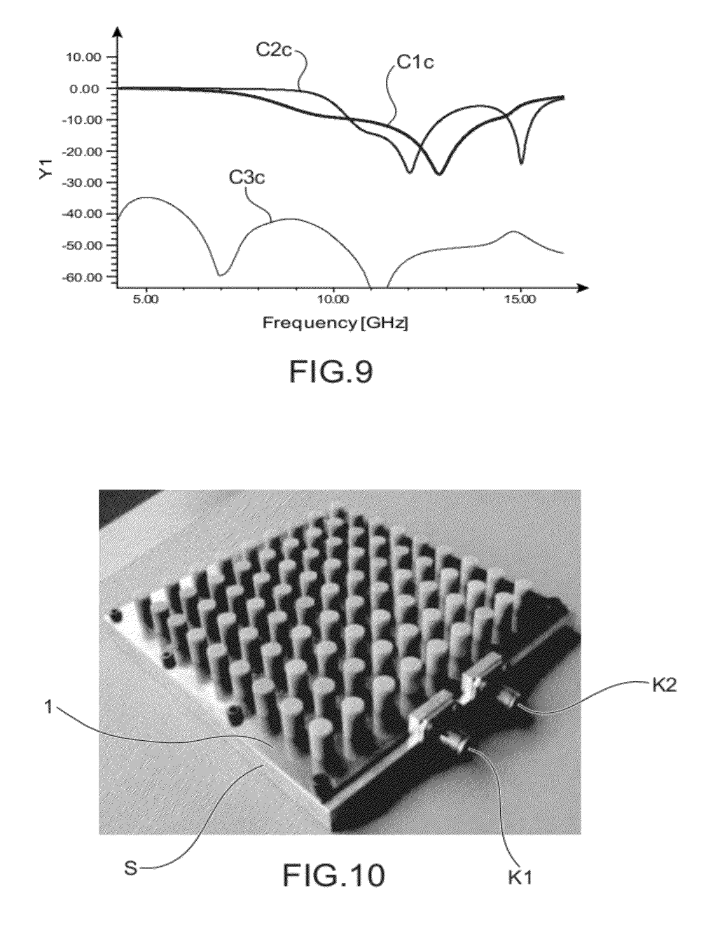

FIG. 9 shows the parameters of a reception antenna according to the second embodiment of the invention.

The curves C1c, C2c and C3c in FIG. 9 show respectively, as a function of the frequency and expressed in decibels, the coefficient of reflection S11c of the port P1, the coefficient of reflection S22c of the port P2 and the coefficient of transmission S21c of the port P1 to the port P2 of the reception antenna. It appears that, in the reception band, the coefficients of reflection S11c and S22c are less than, or even very much less than, −10 dB and that the isolation between the ports P1 and P2 is very greatly less than −40 dB.

Whatever the embodiment of the invention, a particularly advantageous feature of the invention is proposing a dual-polarisation dielectric resonator antenna the coefficient of isolation between ports of which is very small (less than −40 dB). No dual-polarisation dielectric resonator antenna of the prior art has such isolation. This particularly advantageous result is obtained by a novel antenna structure according to claim 1, which is illustrated by the accompanying figures. The dual-polarisation antennas of the prior art have degraded isolation between ports because of the appearance of resonance modes of an order higher than the mode required. Advantageously, the novel structure of the antenna of the invention avoids the appearance of these higher-order resonance modes.

FIG. 10 shows an example of a network antenna according to the invention. The network antenna consists of a matrix of 9×9 elementary dual-polarisation dielectric resonator antennas according to the invention. The 9×9 elementary antennas share the same dielectric substrate 1 and are mounted on the same support S. The ports P1 and P2 of each elementary antenna are respectively connected to electrical connectors K1 and K2 positioned on the same side of the network antenna.

1-6. (canceled)

7. Dual-polarisation antenna comprising:
a microstrip substrate (1) having a first face covered with a metallisation (M) and a second face, opposite to the first face, covered by two microstrip lines (L1, L2) having axes substantially perpendicular to each other, an etching (4) being formed in the metallisation (M), the etching (4) having a cross-section in the form of a rectangle having a large side and a small side, the projection, on the second face, of the axis of symmetry of the rectangle that is parallel to the large side being substantially aligned with the axis of a first line (L1) from the two lines;
a dielectric resonator (2) having the form of a cylinder of revolution fixed, substantially centred, on the etching (4) formed in the metallisation, the axis of the first line (L1) and the axis of the second line (L2) having a point of intersection on the axis of the cylinder of revolution, a first end of the first line forming a first port of the antenna and a first end of the second line forming a second port of the antenna; and
an electrically conductive linear element (3) having an axis substantially parallel to the axis of revolution of the cylinder, the electrically conductive linear element being placed in contact with the dielectric resonator and being electrically connected to a second end of the first line (L1), via a hole (5) formed in the substrate, on the same side as the first face, a second end of the second line (L2) being substantially beyond the etching, the length of the second line (L2) between the first and second ends thereof being substantially equal to one quarter of the wavelength of a wave the frequency of which is the centre frequency of a utilisation band of the antenna.

8. Antenna according to claim 7, in which two additional parallel linear etchings (4) are formed at the ends of the rectangular shaped etching (4) so as to form, with the rectangular shaped etching, an etching in the form of an “H”.

9. Antenna according to claim 7, in which the substrate (1) is made from LTCC ceramic material).

10. Antenna according to claim 7, in which the electrically conductive linear element (3) is a metal rod welded to the second end of the first line (L1).

11. Antenna according to claim 7, in which the electrically conductive linear element (3) consists of a metal element electrically connected to the second end of the first line and a metallisation printed on the dielectric resonator, the metal element being put in electrical contact with the metallisation printed on the dielectric resonator.

12. Network antenna consisting of elementary antennas arranged in the form of N rows and M columns, characterised in that each elementary antenna in the network antenna is a dual-polarisation dielectric resonator antenna according to any one of claims 7 to 11, the first ports of the elementary antennas being connected to a same first electrical connector and the second ports of the elementary antennas being connected to a same second electrical connector.
